(19) United States
(12) Patent Application Publication
(10) Pub. No.: US 2010/0258602 A1
(43) Pub. Date: Oct. 14, 2010

(54) In-flight Case for Portable Audio Visual Device

(76) Inventor: Omar Amin, Irvine, CA (US)

Correspondence Address: GONZALES PATENT SERVICES, 4605 CONGRESS AVE. NW, ALBUQUERQUE, NM, 87114, US

(21) Appl. No.: 12/759,935

(22) Filed: Apr. 14, 2010

Related U.S. Application Data
(60) Provisional application No. 61/169,231, filed on Apr. 14, 2009.

(51) Int. Cl. B60R 7/00; B65D 85/00

(52) U.S. Cl. 224/275; 206/701

(57) ABSTRACT

A case for a portable audio visual device is shown and described. The case has straps which allow the case to be removably secured to an airplane seat back tray table for hands free viewing. The straps may include further modifications which enable them to be removable secured to a car seat headrest or other object.

### CROSS REFERENCE TO RELATED APPLICATIONS

The present application claims the benefit of U.S. Provisional Patent Application Ser. No. 61/169,231 filed Apr. 14, 2009, the entire disclosure of which is hereby incorporated by reference.

### BACKGROUND

People frequent rely on portable audio visual devices (PAVDs) to provide content such as information and entertainment while traveling. These portable audio visual devices may take the form of a small device such as a wireless phone, or game player. Exemplary mobile or wireless phones or game players include, but are not limited to, the iPhone, iPod, and iPad (Apple, Inc., Cupertino, Calif.) or the Nintendo DS (Nintendo of America, Inc. Redmond, Wash.). However, because these devices are typically small, they can be uncomfortable to hold for an extended period of time. Accordingly, it is desirable to provide a “hands-free” case which allows a viewer to watch the content on a PAVD without holding the device in their hands or otherwise strapped to their body.

### SUMMARY OF THE INVENTION

A case for a portable audio visual device is shown and described. According to various embodiments, the case has straps which allow the case to be removably secured to an airplane seat back tray table for hands free viewing. The straps may include further modifications which enable them to be removable secured to a car seat headrest or other object.

### BRIEF DESCRIPTION OF THE DRAWINGS

FIG. 1 is an isometric view of a first embodiment of a PAVD case, as described herein.

FIG. 2 is a bottom view of the PAVD case of FIG. 1.

FIG. 3 is a side view of the PAVD case of FIG. 1.

FIG. 4 is a partially exploded isometric view of a second embodiment of a PAVD case, as described herein.

FIG. 5 is a bottom view of the PAVD case of FIG. 4.

FIG. 6 is a side view of the PAVD case of FIG. 4.

FIG. 7 is an isometric view of a third embodiment of a PAVD case, as described herein.

FIG. 8 is a partially exploded bottom view of the PAVD case of FIG. 7.

FIG. 9 is a side view of the PAVD case of FIG. 7.

FIG. 10 is an isometric view of a fourth embodiment of a PAVD case, as described herein.

FIG. 11 is a bottom view of the PAVD case of FIG. 10.

FIG. 12 is a side view of the PAVD case of FIG. 10.

FIG. 13 is an isometric view of a PAVD case, as described herein, removably secured to an upright and locked airplane seatback tray.

FIG. 14 is an isometric view of a PAVD case, as described herein, removably secured to a car seat headrest.

### DETAILED DESCRIPTION

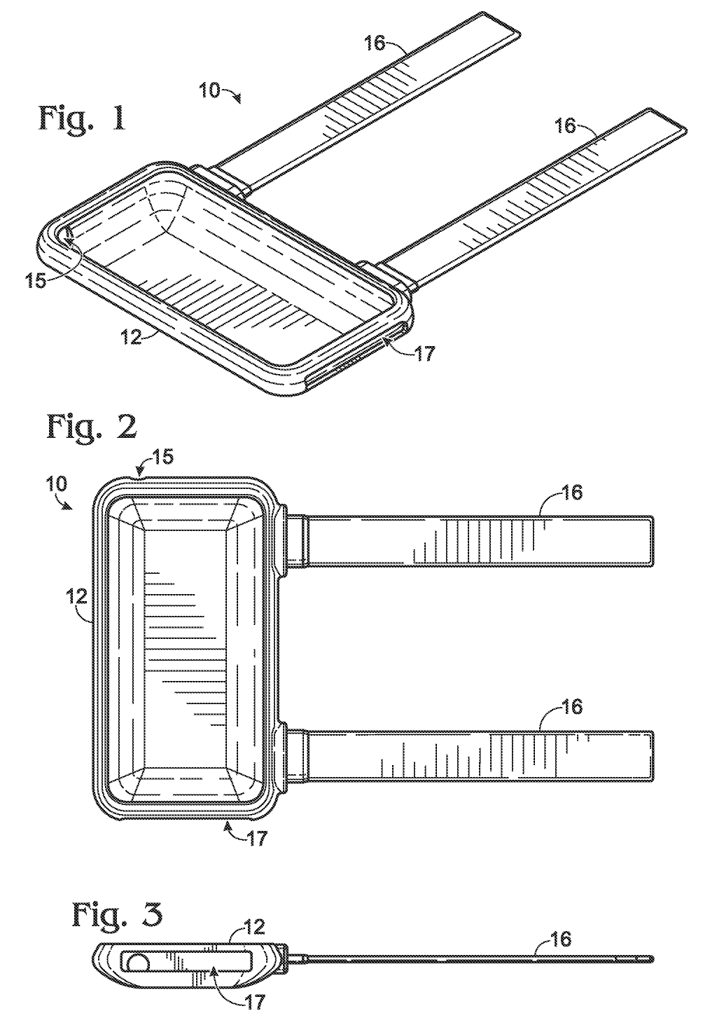

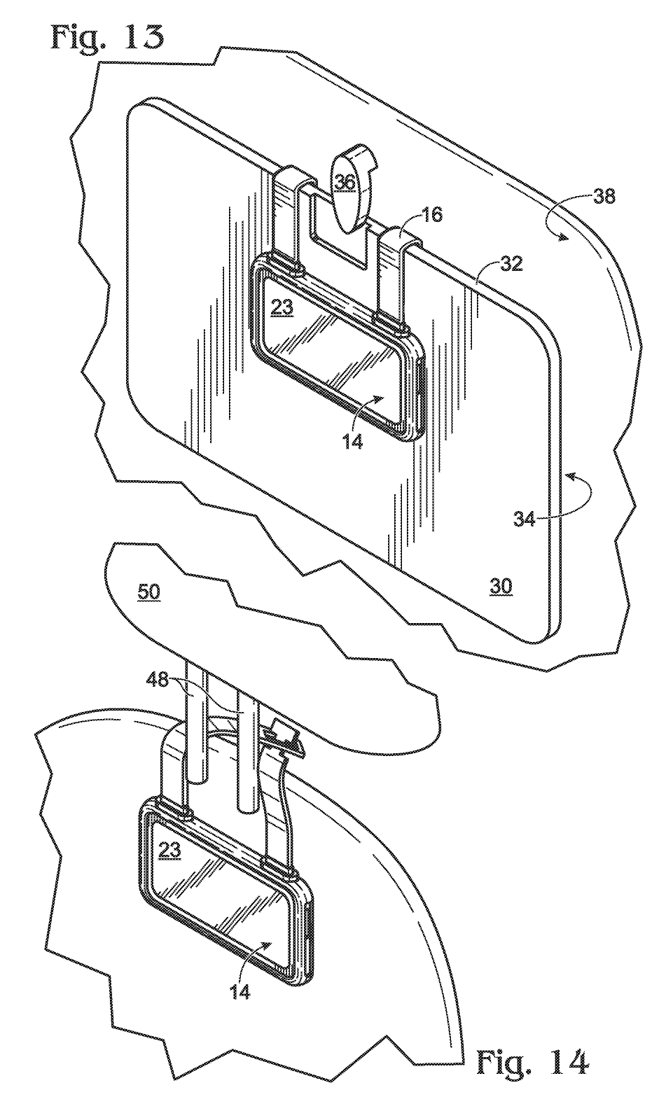

The present disclosure provides a hands free case or cover for a portable audio visual device (PAVD) that is configured to position the device so that it can be viewed without being held by the viewer. According to various embodiments, the case may be removably attached to an upright airline seat tray table, a car seat headrest, an airplane control panel, an exercise machine, or other surface. Exemplary cases and modes of use are shown in FIGS. 1-14.

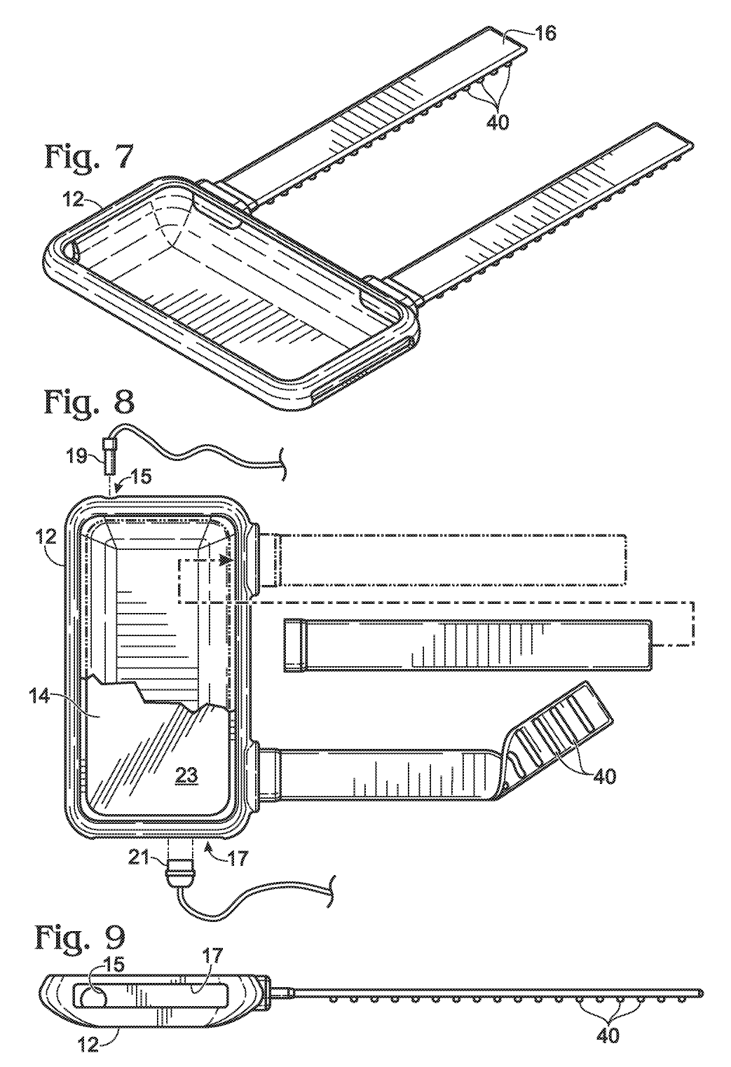

Viewing FIGS. 1-14, case 10 includes a compartment 12, which is configured to receive and contain a PAVD (shown by reference number 14 in FIGS. 8, 13 and 14), while allowing a user to continue to view or otherwise access content provided by the PAVD. According to some embodiments, compartment 12 may be formed of a malleable material, such as silicone rubber, which is configured to conform around the non-display portion of the PAVD while leaving the PAVD's display screen (see reference number 23 in FIG. 8) uncovered or otherwise viewable. Case 10 may also include one or more apertures 15, 17, configured to provide access to various controls, ports, plugs, etc. (see, e.g. reference numbers 19 and 21 in FIG. 8) for operation of the PAVD.

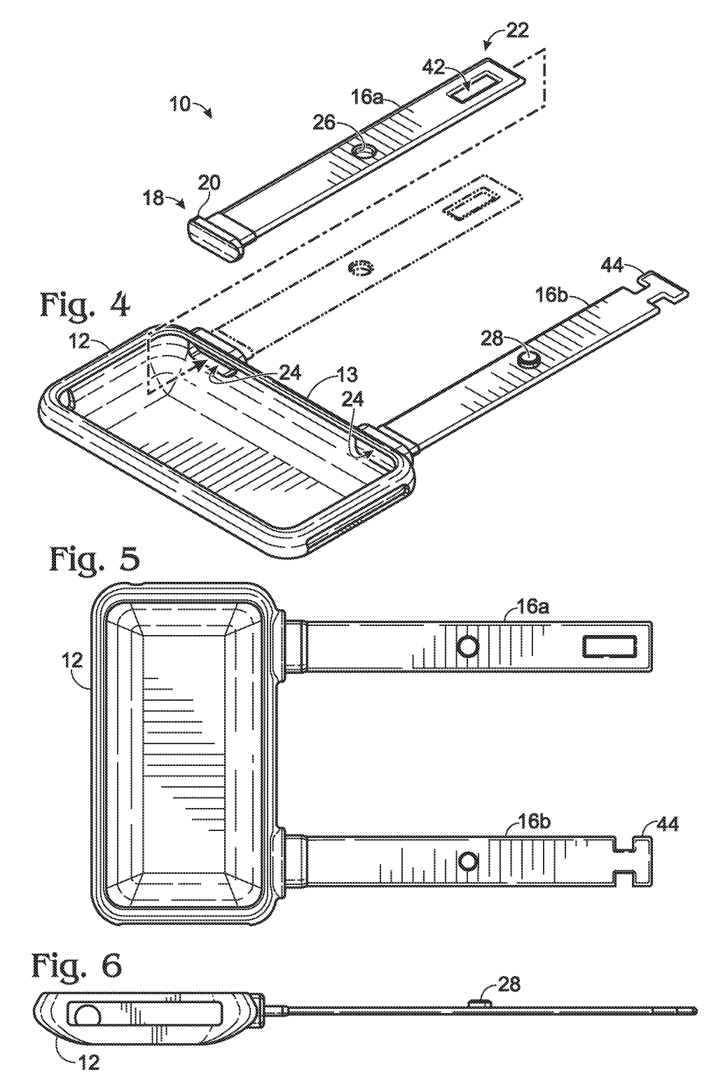

Case 10 further comprises a pair of straps 16 (shown as straps 16a and 16b in FIGS. 4 and 5) which extend outward from edge 13 of the case. (In the embodiment shown, the PAVD will typically be viewed in landscape mode. Accordingly, the case in this embodiment is oriented so that edge 13 is the “top” of the case, when the case is attached to an object. It will be understood that the straps could be located on a different edge of the case in order to provide a different orientation, as desired.) In some embodiments, the straps are permanently attached to the case. For example, the case and straps may be manufactured separately and then permanently attached by gluing, sewing, heat adhesion or other means. Alternatively, the case and straps may be formed from a single mold or a single piece of material.

According to alternate embodiments, the straps may be removable. According to one particular embodiment having removable straps, the proximal end 18 of each strap 16 may include a base 20 which has a slightly larger circumference than the rest of the strap. In order to connect the strap to the compartment, the distal end 22 of the strap may be inserted into an opening 24 in the compartment and pulled through the hole until the base 20 rests against the inner surface of the compartment. Of course other mechanisms for removably attaching the straps to the case may be utilized. It is further noted that the straps may be configured to attach to more than one side of the case, for example in order to provide different views—i.e. landscape and portrait orientations.

In an embodiment in which the straps are removable, it may be desirable to include a mechanism by which the straps can be held together, in order to reduce the likelihood of losing the straps when they are separated from the case. In the embodiment shown in FIGS. 4-6, strap 16a includes a hole 26 which is sized to receive nub 28 in strap 16b and form a friction fit which keeps the two straps together. Of course other mechanisms for joining the straps together could be used.

Turning to FIG. 13, it can be seen that case 10 may be attached to an upright airplane seat back tray table by wrapping the straps up and over the top 32 of the seat tray so that they extend down at least a portion of the back 34 of the tray table. When the seatback tray lock 36 secures the tray table 20 to the back of the airplane seat 38, the case is held in place. Accordingly, straps 16 must be sufficiently malleable that they can wrap up and over the seatback tray, have sufficient thickness that they are held in place by the locked tray table and must be formed of a non-slip material. According to an embodiment, the straps may be formed from a lightweight, durable and malleable material such as a rubber silicone. As shown in FIGS. 3, 6, 9 and 12, according to some embodiments, the straps are pliable, but have sufficient rigidity that they naturally extend outward (i.e. coplanar with) the case, rather than hanging downwards, as would be seen with straps made of fabric. According to one specific embodiment wherein the intended PAVD is an Apple iPhone, the straps are formed from silicone rubber and are between 1 and 3 mm thick, between 12 and 16 cm long, and between 1 and 2 cm wide.

Turning to FIGS. 7-9, according to some embodiments, straps 16 may include a plurality of ridges 40, which help the straps grip the seatback tray table. If the straps are formed from rubber silicone or another similar material, the straps may be molded so as to include the ridges. The ridges may have any desired spacing, but in the depicted embodiment, they extend horizontally across the width of the bottom surface of each strap.

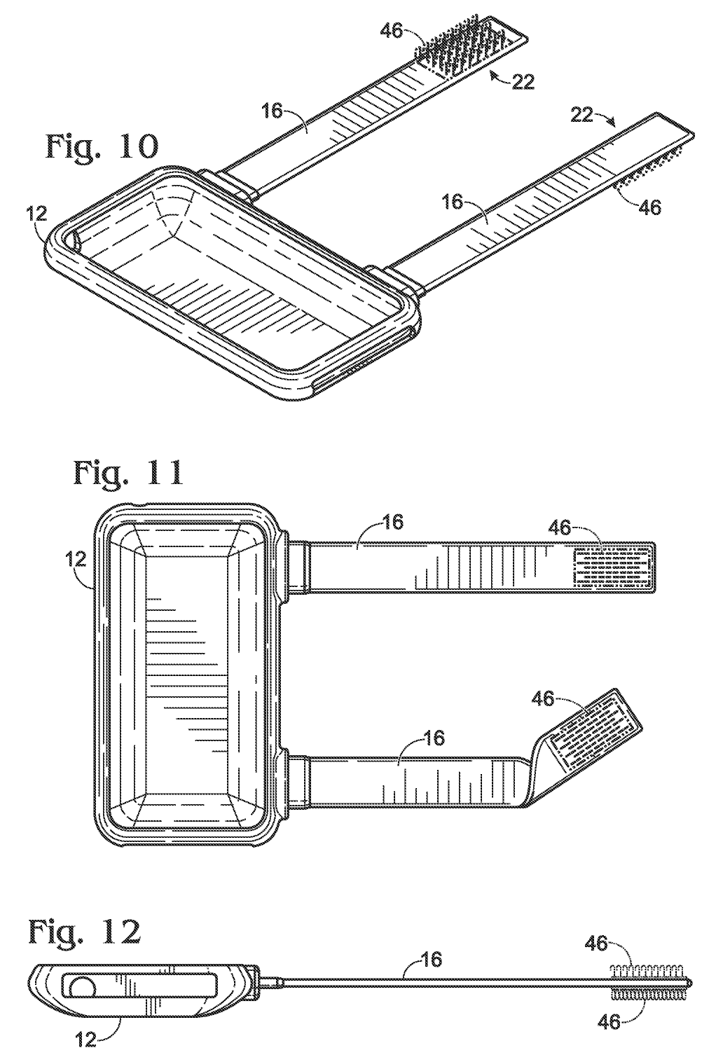

According to various embodiments, the straps may include a mechanism for removably attaching the distal ends of the straps to each other. When the straps are attached to each other and the case, they form a loop which may be used to attach the case to (or hang the case on) an object such as, but not limited to, a car seat headrest. When viewing FIGS. 4-6 in combination with FIG. 14, it can be seen that strap 16a includes a slot 42 and strap 16b includes a hook 44. The straps may be wrapped around an object, such as the post(s) 48 of a car seat head rest 50, and secured together by inserting hook 44 into slot 42. Alternatively, as shown in FIGS. 10-12, the distal end of each strap 16 may include a fabric hook and loop style fastener like Velcro® brand fasteners 46 (Velcro USA, Manchester, N.H.). In this embodiment, one strap may include the hook side of the fastener and one strap may include the loop side, so that the two ends can be secured together to form a ring. It will be understood that this also provides a mechanism for securing the device to other objects and surfaces, simply by securing fabric hook and loop fasteners having the appropriate mating end to the desired object or surface.

It will be appreciated that while the device depicted in the drawings has the general shape of an iPhone (Apple, Inc., Cupertino, Calif.), the case of the present invention could be modified for use with a wide variety of portable audio visual devices including, but not limited to, mobile phones, hand held game players, hand held computing devices and the like. Furthermore, while the depicted device is shown and described as being used with an airline seatback tray table and car seat head rest, it will be appreciated that the use of the present case is not to be limited to only those objects which are specifically described and shown herein.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications. As used herein and in the appended claims, the singular forms “a,” “an,” and “the” include plural reference unless the context clearly dictates otherwise.

Under no circumstances may this disclosure be interpreted to be limited to the specific examples or embodiments or methods specifically disclosed herein. The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention.

What is claimed is:

1. A portable electronic audio visual device (PAVD) case comprising:
a body configured to receive the portable electronic audio visual device; and
a securing mechanism affixed to the body, the securing mechanism being configured to removably secure the body to an upright and locked airplane seatback tray table.

2. The PAVD case of claim 1 wherein the securing mechanism comprises two straps extending from a side of the body.

3. The PAVD case of claim 2 wherein the bottom of each strap comprises a plurality of ridges.

4. The PAVD case of claim 2 wherein the straps are formed from silicone rubber.

5. The PAVD case of claim 2 wherein the straps are removably attached to the body.

6. The PAVD case of claim 5 wherein the proximal end of each strap includes an enlarged base portion and the body includes a hole for each strap wherein the base and hole are sized such that the base is not able to fit through the hole.

7. The PAVD case of claim 2 wherein one straps include a mechanism for attaching the distal ends of the straps to each other.

8. The PAVD case of claim 7 wherein the distal end of each strap includes one side of a hook and loop style fastener.

9. The PAVD case of claim 7 wherein the distal end of one strap has a slot and the distal end of the other strap is formed into a hook configured to securely and removably fit into the slot.

10. A hands free positioning device for a PAVD comprising:
a body configured to receive a PAVD; and
two malleable non-slip straps extending from one side of the body.

11. The hands free positioning device of claim 10 wherein the distal ends of the straps include a mechanism for removably securing the straps to each other.

12. The hands free positioning device of claim 11 wherein the distal ends of each strap includes one side of a hook and loop style fastener.

13. The hands free positioning device of claim 11 wherein the distal end of one strap has a slot and the distal end of the other strap is formed into a hook configured to securely and removably fit into the slot.

14. The hands free positioning device of claim 13 wherein the straps are removably attached to the body.

15. The hands free positioning device of claim 14 wherein the proximal end of each strap includes an enlarged base portion and the body includes a hole for each strap wherein the base and hole are sized such that the base is not able to fit through the hole.

16. The hands free positioning device of claim 14 wherein the straps are formed of silicone rubber.

17. The hands free positioning device of claim 10 wherein the straps are between 1 and 3 mm thick.

18. The hands free positioning device of claim 10 wherein the straps are between 1 and 2 cm wide and between 12 and 16 cm long.

19. The hands free positioning device of claim 10 wherein the straps have sufficient rigidity that absent application of an external force, they naturally extend coplanar with the body of the case.
